(19) United States
(12) Patent Application Publication
(10) Pub. No.: US 2023/0141646 A1
(43) Pub. Date: May 11, 2023

(54) SHOWER SET

(71) Applicant: Fei WANG, Huizhou City (CN)

(72) Inventor: Fei WANG, Huizhou City (CN)

(21) Appl. No.: 17/747,742

(22) Filed: May 18, 2022

(30) Foreign Application Priority Data
Nov. 8, 2021 (CN) 2021113146232
Mar. 14, 2022 (CN) 2022205531524

(51) Int. Cl. A61C 17/032; A61C 17/02; E03C 1/04; E03C 1/042

(52) U.S. Cl. CPC A61C 17/032; A61C 17/0202; E03C 1/0408; E03C 1/042

(57) ABSTRACT

The shower set includes a water outlet end and an oral irrigator. A water inlet of the oral irrigator communicates with the water outlet end; to cause the oral irrigator to spray water received from the water outlet end out of the oral irrigator under the action of a water level or water pressure of the water outlet end. The technical problem in the related art of inconvenient use of an oral irrigator during showering is resolved.

### CROSS-REFERENCE TO RELATED APPLICATIONS

This application claims priority to Chinese Patent Application No. 2021113146232, filed to the China National Intellectual Property Administration on Nov. 8, 2021 and entitled “Shower Set Having Oral Irrigator”, the disclosure of which is hereby incorporated by reference in its entirety.

This application further claims priority to Chinese Patent Application No. 2022205531524, filed to the China National Intellectual Property Administration on Mar. 14, 2022 and entitled “Oral Irrigator and Adapter Thereof”, the disclosure of which is hereby incorporated by reference in its entirety.

See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This application relates to the technical field of hygienic products, and specifically, to a shower set.

### 2. Description of Related Art Including Information Disclosed Under 37 CFR 1.97 and 37 CFR 1.98

An oral irrigator is an auxiliary tool for cleaning an oral cavity, and is a tool for cleaning teeth and interdental spaces by means of impulse water current impact, which mainly includes a portable oral irrigator and a desktop oral irrigator, with a general irrigation pressure ranging from 0 to 90 psi.

Most of the conventional oral irrigators have own electric pumps to generate water pressure. Although it is possible to rinse the teeth, it increases energy consumption, and the oral irrigators still need to be powered on during showering, which poses certain safety risks and reduces the convenience of using the oral irrigators.

In view of inconvenient use of the oral irrigators during showering in the related art, no effective solution has been proposed yet.

### BRIEF SUMMARY OF THE INVENTION

This application is mainly intended to provide a shower set, to resolve inconvenient use of an oral irrigator during showering in the related art.

In order to implement the above objective, a first aspect of this application provides a shower set.

The shower set in this application includes a water outlet end and an oral irrigator.

A water inlet of the oral irrigator communicates with the water outlet end, to cause the oral irrigator to spray water received from the water outlet end out of the oral irrigator under the action of a water level or water pressure of the water outlet end.

Optionally, the shower set includes a top spray shower. The top spray shower is connected to a shower rod. An end of the shower rod is connected to a tee water outlet. Two sides of the tee water outlet respectively communicate with the oral irrigator and the telescoping top spray shower by using a first aqueduct and a second aqueduct. The end of the shower rod away from the top spray shower is connected to a switch and a cold and hot water converter.

Optionally, a side of the tee water outlet is provided with a first water-receiving port. A bottom of the shower rod is provided with a second water-receiving port. An end of the first aqueduct away from the oral irrigator is provided with a multi-functional interface. The multi-functional interface is cooperatively connected to the first water-receiving port or the second water-receiving port.

Optionally, a four-gear adjustment switch is arranged at the tee water outlet.

Optionally, a positioning member is fixedly sleeved on the shower rod. The other end of the positioning member is fixedly connected to a wall.

Optionally, a placement rack is arranged outside the shower rod. The placement rack is a square rack and has semicircular grooves on two ends. The semicircular grooves are respectively mated with the oral irrigator and the telescoping top spray shower.

Optionally, the shower set further includes an adapter. The adapter includes a connection housing, a water collection cover, and a fixed block.

The connection housing is sleeved on a nozzle of the top spray shower. The water collection cover is connected to a lower end of the connection housing, and is located under the nozzle. A lower end of the water collection cover is connected to the water inlet of the oral irrigator. The fixed block is fixed on an upper end of the connection housing, and is located above the nozzle, to limit the connection housing from separating from the nozzle.

Optionally, the annular fixed block is threadedly connected in the connection housing. A lower end surface of the fixed block is a slope to cause the lower end surface of the fixed block to attach to an upper end of the nozzle.

Optionally, the adapter further includes a seal ring. The seal ring is arranged between the fixed block and the nozzle.

Optionally, the seal ring includes two semicircular seal rings that are spliced together.

Optionally, the adapter further includes an isolation block. The isolation block is arranged between the seal ring and the nozzle, and is packaged at a splicing part of the two semicircular seal rings.

Optionally, the isolation block is made of rubber.

Optionally, the fixed block includes two semicircular fixed blocks that are spliced together.

Optionally, the connection housing includes two half housings that are spliced together.

Optionally, a handheld block is arranged on an upper end of the fixed block.

Optionally, the oral irrigator includes a water storage pot, a filter element, and a water nozzle.

An anti-slip handle is arranged on a side of the water storage pot. A side of the water storage pot close to the first aqueduct is provided with a water inlet.

The filter element is arranged between the water storage pot and the water inlet.

The water nozzle is movably connected to an end of the water storage pot away from the water inlet. A rotary gasket is movably connected between the water nozzle and the water storage pot.

Optionally, a 30° inclination angle is designed on an end of the water nozzle away from the water storage pot.

In this embodiment of this application, the shower set is provided. The water outlet end and the oral irrigator are arranged. The water inlet of the oral irrigator communicates with the water outlet end, to cause the oral irrigator to spray the water received from the water outlet end out of the oral irrigator under the action of the water level or water pressure of the water outlet end. In this way, the oral irrigator in the shower set uses the water level or the water pressure of the water outlet end to cause the water entering the oral irrigator to have certain kinetic energy, and then the oral irrigator uses the kinetic energy to spray the water out, so that the oral irrigator may achieve tooth rinsing without connecting electric energy. Therefore, the use convenience of the oral irrigator can be improved, and energy consumption can be reduced. Therefore, the inconvenient use of the oral irrigator during showering in the related art is resolved.

### BRIEF DESCRIPTION OF THE SEVERAL VIEWS OF THE DRAWINGS

In order to more clearly illustrate the embodiments of this application or the technical solutions in the prior art, the drawings used in the description of the embodiments or the prior art will be briefly described below. It is apparent that the drawings in the following descriptions are some embodiments of this application. Other drawings can be obtained from those skilled in the art according to these drawings without any creative work.

FIG. 1 is a front elevation view of a shower set according to an embodiment of this application.

FIG. 2 is a side elevation view of a shower set according to an embodiment of this application.

FIG. 3 is a schematic view of a structural diagram of an oral irrigator according to an embodiment of this application.

FIG. 4 is a schematic view of a structural diagram of an adapter according to an embodiment of this application.

FIG. 5 is a schematic view of a structural diagram of a fixed block and a connection housing according to an embodiment of this application.

### DETAILED DESCRIPTION OF THE INVENTION

Implementations of this application are further described in detail below with reference to the accompanying drawings and embodiments. The following embodiments are used to illustrate this application, but not to limit the scope of this application.

It is to be noted that terms “first”, “second” and the like in the description, claims and the above mentioned drawings of this application are used for distinguishing similar objects rather than describing a specific sequence or a precedence order. It should be understood that the data used in such a way may be exchanged where appropriate, in order that the embodiments of this application described here can be implemented. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

In this application, orientation or position relationships indicated by terms “upper”, “lower”, “left”, “right”, “front”, “back”, “top”, “bottom”, “inside”, “outside” “in”, “vertical”, “horizontal”, “transverse”, “longitudinal” and the like are orientation or position relationships shown in the drawings. These terms are mainly used to better describe this application and its embodiments, rather than limit that the indicated devices, components and constituting parts must be in specific orientations or structured and operated in the specific orientations.

Furthermore, the above mentioned part of terms may be not only used to represent the orientation or position relationships, but used to represent other meanings, for example, term “on” may be used to represent certain relationship of dependence or connection relationship in some cases. For those of ordinary skill in the art, specific meanings of these terms in this application may be understood according to a specific condition.

In addition, terms “mount”, “configure”, “provide”, “connect”, “communicate” and “fix” should be broadly understood. For example, the term “connect” may be fixed connection, detachable connection or integral construction. As an alternative, the term “connect” may be mechanical connection, or electrical connection. As an alternative, the term “connect” may be direct connection, or indirect connection through a medium, or communication in two devices, components or constituting parts. For those of ordinary skill in the art, specific meanings of the above mentioned terms in this application may be understood according to a specific condition.

In addition, the term “a plurality of” shall refer to two or more than two.

It is to be noted that the embodiments in this application and the features in the embodiments may be combined with one another without conflict. This application will now be described below in detail with reference to the drawings and the embodiments.

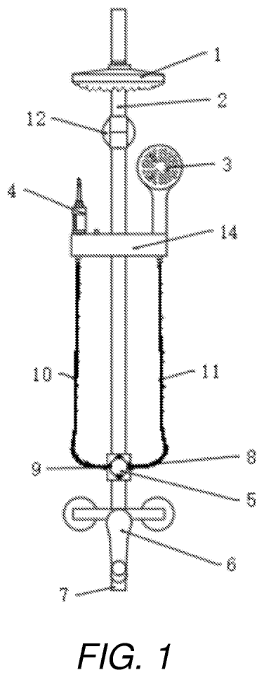

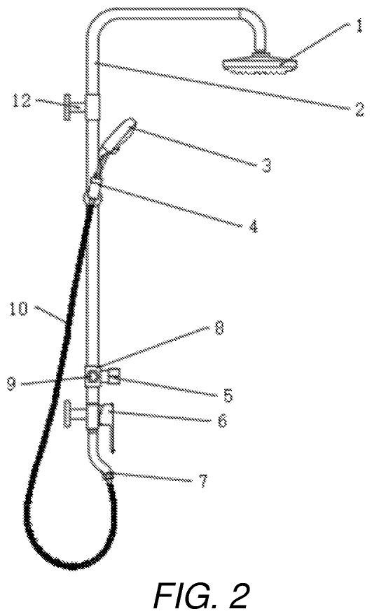

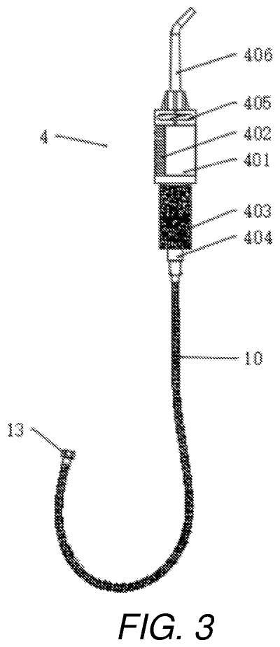

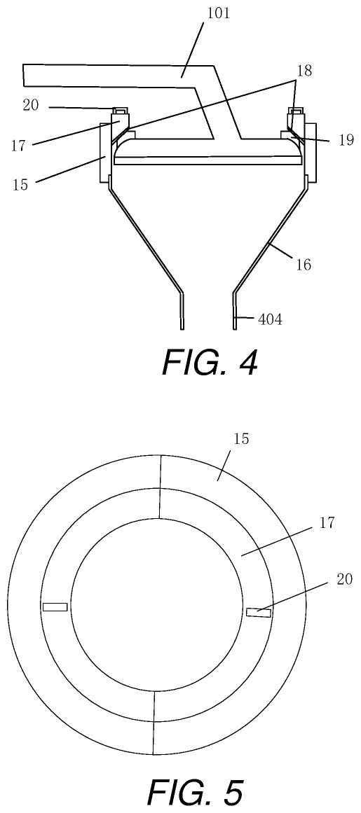

As shown in FIG. 1 to FIG. 5, an embodiment of this application provides a shower set. The shower set includes a water outlet end and an oral irrigator 4.

A water inlet 404 of the oral irrigator 4 communicates with the water outlet end, to cause the oral irrigator 4 to spray water received from the water outlet end out of the oral irrigator 4 under the action of a water level or water pressure of the water outlet end.

Specifically, the oral irrigator 4 in the shower set uses the water level or the water pressure of the water outlet end to cause the water entering the oral irrigator 4 to have certain kinetic energy, and then the oral irrigator 4 uses the kinetic energy to spray the water out, so that the oral irrigator 4 may achieve tooth rinsing without connecting electric energy. Therefore, the use convenience of the oral irrigator 4 can be improved, and energy consumption can be reduced.

Optionally, the shower set provided in this embodiment of this application further includes a top spray shower 1. The top spray shower 1 is connected to a shower rod 2. An end of the shower rod 2 is connected to a tee water outlet 8. Two sides of the tee water outlet 8 respectively communicate with the oral irrigator 4 and the telescoping top spray shower 1 by using a first aqueduct 10 and a second aqueduct 11. The end of the shower rod 2 away from the top spray shower 1 is connected to a switch and a cold and hot water converter 6.

Specifically, the first aqueduct 10 may be used as the water outlet end of the shower set. A shower requirement of a user may be met by using the top spray shower 1 and a telescoping shower 3. By using the oral irrigator 4, the user may rinse the teeth with water pressure during showering, so that the energy consumption of a conventional oral irrigator 4 using battery power is avoided, and the high cost of the conventional oral irrigator 4 is reduced. In addition, a cell is mounted on a side surface of the conventional oral irrigator 4, which may leak for long-time use, so that the conventional oral irrigator 4 does not rinse the teeth with saline or medication. However, the oral irrigator 4 in this application well avoids these defects.

Optionally, the oral irrigator 4 includes a water storage pot 401, a filter element 403, and a water nozzle 406.

An anti-slip handle 402 is arranged on a side of the water storage pot 401. A side of the water storage pot 401 close to the first aqueduct 10 is provided with a water inlet 404.

The filter element 403 is arranged between the water storage pot 401 and the water inlet 404.

The water nozzle 406 is movably connected to an end of the water storage pot 401 away from the water inlet 404. A rotary gasket is movably connected between the water nozzle 406 and the water storage pot 401.

Optionally, a 30° inclination angle is designed on an end of the water nozzle 406 away from the water storage pot 401.

Specifically, the oral irrigator 4 may be prevented from dropping during use by using the anti-slip handle 402. The water storage pot 401 may store the saline or medicinal plants. The saline or medicinal plants are diluted with water in various proportions according to requirements, so that better tooth cleaning and dental care effects may be achieved by rinsing the teeth. Through the arrangement of the filter element 403 between the water inlet 404 and the water storage pot 401, water may be filtered, so that the water entering the oral cavity can be guaranteed to be clean and sanitary. Bursts of water current may be formed by movably arranging the rotary gasket 405 between the water nozzle 406 and the water storage pot 401, so that the teeth in the oral cavity can be effectively rinsed. The end of the water nozzle 406 away from the water storage pot 401 may extend into the oral cavity, and the end of the water nozzle 406 extending into the oral cavity is designed with the 30° inclination angle, so that the oral cavity and the teeth are conveniently rinsed.

Optionally, a side of the tee water outlet 8 is provided with a first water-receiving port 9. A bottom of the shower rod 2 is provided with a second water-receiving port 7. An end of the first aqueduct 10 away from the oral irrigator 4 is provided with a multi-functional interface 13. The multi-functional interface 13 is cooperatively connected to the first water-receiving port 9 or the second water-receiving port 7.

Optionally, a four-gear adjustment switch 5 is arranged at the tee water outlet 8.

Specifically, the user may rotate the four-gear adjustment switch 5 to flexibly control the opening and closing of the top spray shower 1, the oral irrigator 4, and the telescoping shower 3, so that the use requirements of the user can be met. When the four-gear adjustment switch 5 is rotated to a side corresponding to the oral irrigator 4, the water current enters the oral irrigator 4 by using the first aqueduct 10. In the oral irrigator 4, the water current first passes through the filter element 403, and the filter element 403 may effectively filter the water. The water current passing through the filter element 403 drives the saline or medicinal plants in the water storage pot 401 to dilute the saline or medicinal plants for rinsing the teeth, so that better tooth cleaning and dental care effects can be achieved. By arranging the water nozzle 406 with the 30° inclination angle, the teeth in various positions may be rinsed, so that the efficiency of teeth rinsing can be enhanced. The water nozzles 406 of various specifications may be mounted on the water storage pot 401 according to actual requirements, and can be flexibly dismounted and replaced, so that different tooth-rinsing requirements of different populations can be met. The oral irrigator 4 is connected to a conventional shower or a water faucet by using the multi-functional interface 13 of the first aqueduct 10 for use.

Optionally, a positioning member 12 is fixedly sleeved on the shower rod 2. The other end of the positioning member 12 is fixedly connected to a wall.

Optionally, a placement rack 14 is arranged outside the shower rod 2. The placement rack 14 is a square rack and has semicircular grooves on two ends. The semicircular grooves are respectively mated with the oral irrigator 4 and the telescoping top spray shower 1.

Specifically, the shower rod 2 may be stably mounted on the wall by using the positioning member 12. Through the arrangement of the semicircular grooves on the two ends of the placement rack 14, positions of the oral irrigator 4 and the telescoping shower 3 can be respectively fixed, so that the idle oral irrigator 4 and the telescoping shower 3 can be conveniently clamped.

Optionally, the shower set further includes an adapter. The adapter includes a connection housing 15, a water collection cover 16, and a fixed block 17.

The connection housing 15 is sleeved on a nozzle 101 of the top spray shower 1. The water collection cover 16 is connected to a lower end of the connection housing 15, and is located under the nozzle 101. A lower end of the water collection cover 16 is connected to the water inlet 404 of the oral irrigator 4. The fixed block 17 is fixed on an upper end of the connection housing 15, and is located above the nozzle 101, to limit the connection housing 15 from separating from the shower nozzle 101.

Specifically, the connection housing 15 is sleeved on the nozzle 101 of the top spray shower 1. Then the connection housing 15 and the water collection cover 16 are both fixed on the nozzle 101 of the top spray shower 1 by using the fixed block 17 above the nozzle 101. Water sprayed from the nozzle 101 of the top spray shower 1 is collected by the water collection cover 16, and then inputted into the water inlet 404 of the oral irrigator 4. In this way, a purpose of getting water by the oral irrigator 4 by using the nozzle 101 of the top spray shower 1 without surplus water outlet ends in the shower set can be achieved. In this way, the nozzle 101 of the top spray shower 1 may be used as the water outlet end of the shower set.

Optionally, the annular fixed block 17 is threadedly connected in the connection housing 15. A lower end surface of the fixed block 17 is a slope to cause the lower end surface of the fixed block 17 to attach to an upper end of the nozzle 101.

Specifically, the fixed block 17 is in an annular shape, so that the fixed block 17 may be sleeved on a water pipe on the nozzle 101. The outside of the fixed block 17 and an inner wall of the connection housing 15 are both provided with threads, so that the fixed block 17 may be threadedly connected to the inner wall of the connection housing 15. Since the lower end surface of the fixed block 17 is the slope, the lower end surface of the fixed block 17 may be attached to the upper end of the nozzle 101.

Optionally, the oral irrigator 4 provided in this embodiment of this application further includes a seal ring 18. The seal ring 18 is arranged between the fixed block 17 and the nozzle 101.

Specifically, by sealing a gap between the fixed block 17 and the nozzle 101 by using the seal ring 18, the water sprayed from the nozzle 101 is prevented from splashing from the gap between the fixed block 17 and the nozzle 101. The seal ring 18 has an inner cavity, and the inner cavity is filled with liquid. The seal ring 18 has a certain elasticity. With the pressing of the fixed block 17, after the seal ring 18 is pressed, the internal liquid flows to fill the gap between the nozzle 101 and the fixed block 17. Compared with a conventional seal ring 18, the seal ring 18 has a better filling effect for the gap.

Optionally, the seal ring 18 includes two semicircular seal rings 18 that are spliced together.

Specifically, the seal ring 18 includes two semicircular seal rings 18 that are spliced together. In this way, when the adapter is not used, the seal ring 18 may be disassembled from the top spray shower 1.

Optionally, the oral irrigator 4 provided in this embodiment of this application further includes an isolation block 19. The isolation block 19 is arranged between the seal ring 18 and the nozzle 101, and is packaged at a splicing part of the two semicircular seal rings 18.

Specifically, tightness may be further enhanced by packaging the isolation block 19 at the splicing part of the two semicircular seal rings 18.

Specifically, the isolation block 19 is made of an elastic sealing material.

Specifically, the elastic sealing material includes rubber.

Optionally, an upper end surface of the isolation block 19 is provided with a slope matching the slope of the fixed block 17.

Specifically, during a screwed connection between the fixed block 17 and a connection block, as the fixed block 17 is continuously screwed in, the slope of the fixed block 17 is tightly attached to the slope of the isolation block 19, so that a sealing effect between the connection housing 15 and the nozzle 101 can be guaranteed.

Optionally, the fixed block 17 includes two semicircular fixed blocks 17 that are spliced together.

Specifically, the fixed block 17 includes two semicircular fixed blocks 17 that are spliced together. In this way, when the adapter is not used, the fixed block 17 may be disassembled from the top spray shower 1.

Optionally, the connection housing 15 includes two half housings that are spliced together.

Specifically, the connection housing 15 includes two half housings that are spliced together. In this way, when the adapter is not used, the connection housing 15 may be disassembled from the top spray shower 1.

Optionally, a handheld block 20 is arranged on an upper end of the fixed block 17.

Specifically, the handheld block 20 is arranged on the upper end of the fixed block 17, so that the fixed block 17 is conveniently rotated by using the handheld block 20.

In this embodiment of this application, during use, a valve of the top spray shower 1 is opened, so that clear water is sprayed from the nozzle 101 of the top spray shower 1, and then under the guidance of the water collection cover 16, the water enters the water inlet 404 of the oral irrigator 4, and is finally sprayed from the oral irrigator 4.

In this embodiment of this application, the shower set is provided. The water outlet end and the oral irrigator 4 are arranged. The water inlet 404 of the oral irrigator 4 communicates with the water outlet end, to cause the oral irrigator 4 to spray the water received from the water outlet end out of the oral irrigator 4 under the action of the water level or water pressure of the water outlet end. In this way, the oral irrigator 4 in the shower set uses the water level or the water pressure of the water outlet end to cause the water entering the oral irrigator 4 to have certain kinetic energy, and then the oral irrigator 4 uses the kinetic energy to spray the water out, so that the oral irrigator 4 may achieve tooth rinsing without connecting electric energy. Therefore, the use convenience of the oral irrigator 4 can be improved, and energy consumption can be reduced. Therefore, the inconvenient use of the oral irrigator during showering in the related art is resolved.

It is to be noted at last: the above various embodiments are only used to illustrate the technical solutions of this application and not used to limit the same. Although this application has been described in detail with reference to the foregoing embodiments, for those of ordinary skill in the art, they can still modify the technical solutions described in the foregoing embodiments, or equivalently replace part of the technical features; all these modifications and replacements shall not cause the essence of the corresponding technical solutions to depart from the spirit and the scope of the technical solutions of the embodiments of this application.

1. A shower set, comprising
a water outlet end, and
an oral irrigator,
having a water inlet in communication with the water outlet end, so as to cause the oral irrigator to spray water received from the water outlet end out of the oral irrigator under the action of a water level or water pressure of the water outlet end.

2. The shower set as claimed in claim 1, further comprising:
a top spray shower, wherein the top spray shower is connected to a shower rod; an end of the shower rod is connected to a tee water outlet; two sides of the tee water outlet respectively communicate with the oral irrigator and the telescoping top spray shower by using a first aqueduct and a second aqueduct;
and the end of the shower rod away from the top spray shower is connected to a switch and a cold and hot water converter.

3. The shower set as claimed in claim 2, wherein a side of the tee water outlet is provided with a first water-receiving port; a bottom of the shower rod is provided with a second water-receiving port; an end of the first aqueduct away from the oral irrigator is provided with a multi-functional interface; and the multi-functional interface is cooperatively connected to the first water-receiving port or the second water-receiving port.

4. The shower set as claimed in claim 2, wherein a four-gear adjustment switch is arranged at the tee water outlet.

5. The shower set as claimed in claim 2, wherein a positioning member is fixedly sleeved on the shower rod; and the other end of the positioning member is fixedly connected to a wall.

6. The shower set as claimed in claim 2, wherein a placement rack is arranged outside the shower rod; the placement rack is a square rack and has semicircular grooves on two ends; and the semicircular grooves are respectively mated with the oral irrigator and the telescoping top spray shower.

7. The shower set as claimed in claim 1, further comprising:
an adapter,
wherein the adapter comprises a connection housing, a water collection cover, and a fixed block;
wherein the connection housing is sleeved on a nozzle of the top spray shower;
wherein the water collection cover is connected to a lower end of the connection housing, and is located under the nozzle;
wherein a lower end of the water collection cover is connected to the water inlet of the oral irrigator; and
wherein the fixed block is fixed on an upper end of the connection housing, and is located above the nozzle, to limit the connection housing from separating from the nozzle.

8. The shower set as claimed in claim 7, wherein the annular fixed block is threadedly connected in the connection housing; and a lower end surface of the fixed block is a slope to cause the lower end surface of the fixed block to attach to an upper end of the nozzle.

9. The shower set as claimed in claim 7, wherein the adapter further comprises a seal ring, and the seal ring is arranged between the fixed block and the nozzle.

10. The shower set as claimed in claim 9, wherein the seal ring comprises two semicircular seal rings that are spliced together.

11. The shower set as claimed in claim 10, wherein the adapter further comprises an isolation block; and the isolation block is arranged between the seal ring and the nozzle, and is packaged at a splicing part of the two semicircular seal rings.

12. The shower set as claimed in claim 11, wherein the isolation block is made of rubber.

13. The shower set as claimed in claim 8, wherein the fixed block comprises two semicircular fixed blocks that are spliced together.

14. The shower set as claimed in claim 7, wherein the connection housing comprises two half housings that are spliced together.

15. The shower set as claimed in claim 7, wherein a handheld block is arranged on an upper end of the fixed block.

16. The shower set as claimed in claim 2, wherein the oral irrigator comprises:
a water storage pot, wherein an anti-slip handle is arranged on a side of the water storage pot, and a side of the water storage pot close to the first aqueduct is provided with a water inlet;
a filter element, arranged between the water storage pot and the water inlet; and
a water nozzle, movably connected to an end of the water storage pot away from the water inlet, wherein a rotary gasket is movably connected between the water nozzle and the water storage pot.

17. The shower set as claimed in claim 16, wherein a 30° inclination angle is designed on an end of the water nozzle away from the water storage pot.
